(19) United States
(12) Patent Application Publication
(10) Pub. No.: US 2011/0260067 A1
(43) Pub. Date: Oct. 27, 2011

(54) DETECTING BAR PERMITTING TO MEASURE THE DOI FOR HIGH-PERFORMANCE TEP IMAGING

(76) Inventors: Najia Tamda, Noironte (FR); Aboubakr Bakkali, Noironte (FR)

(21) Appl. No.: 12/937,250

(22) PCT Filed: Apr. 9, 2009
(86) PCT No.: PCT/IB09/52790

§ 371 Date: Mar. 24, 2011

(30) Foreign Application Priority Data
Apr. 10, 2008 (FR) FR 08 52406
Apr. 10, 2008 (FR) FR 08 52407
Jun. 2, 2008 (FR) FR 08 53598
Nov. 20, 2008 (FR) FR 08 57890

(51) Int. Cl. G01T 1/202; G01T 1/164

(52) U.S. Cl. 250/362; 250/361 R; 250/363.03

(57) ABSTRACT

The invention concerns an optical weighing method for measuring a DOI by-estimating the position (X) at the time of impact of a gamma photon in a crystalline medium, which has a juxtaposition of sections between which are created the conditions for a discrete energy loss of known magnitude, and wherein is compared the energy (E1; E2) collected by photodetectors (4,-5), mounted at longitudinal ends (2; 3) of said medium for estimating said position (X) in a given segment. The invention concerns a device including a photon detecting bar (1) including a single crystal extending along a longitudinal direction, including photodetectors at each end on flat surfaces perpendicular to said direction, It is characterized in that it includes a succession of single-crystalline bar lengths, homogeneous, isotropic and full, separated by dioptric mediums and/or openings parallel with said flat surfaces.

### BACKGROUND OF THE INVENTION

(1) Field of the Invention

The invention relates to an optical weighing method for estimating the position of impact of a gamma photon in a crystalline medium.

The invention also related to a gamma photon detecting bar, designed capable of implementing this method and including at least one single crystal.

The invention relates to the field of radio-isotopic functional imaging and, in particular, of biphotonic imaging referred to as positron emission tomography or PET. The bar according to the invention is intended, in particular, at equipping a module for detecting and localizing a radioactive tracer.

Nuclear imaging consists, in its principle, in administering a tracer containing molecules marked by a radioactive isotope, in order to follow up through external detection, the normal or pathologic functioning of a given organ.

Within the framework of the positron emission tomography (PET), the tracer is injected into a patient by intravenous injection and will be fixed to the cells involved in order to emit positrons. Once emitted, the positron travels over a distance of some millimeters in the tissues and looses its kinetic energy. In this rest position, the positron interacts with an electron of the medium, following an annihilation reaction during which the masses of these two particles are transformed into two gamma photons or annihilation photons doped with a defined level of energy. These photons are emitted simultaneously, co-linearly and in opposite directions. These characteristics are used for localizing the direction of emission of the annihilation photons without using a collimator. This direction of emission is referred to as line of response, or LOR. This LOR contains the position of the positron source.

The images obtained in positron emission tomography, referred to as TEP, result from a tomographic reconstruction process, which estimates, from all the lines of response acquired by the system, the three-dimensional distribution of the radioactive tracer in the organ to be examined.

The detection of the gamma photons is ensured by properly arranged bars, each comprised of at least one detecting bar connected to an electronic device ensuring the processing and tomographic reconstruction process providing the image sought. The detecting bar is formed of a scintillating crystal, which converts the photon energy into an isotropic emission of light-emitting photons likely to be detected by at least one photodetector located proximate the crystal and which is designed capable of measuring the energy received.

(2) Description of the Prior Art

In the apparatuses presently used, the images obtained in PET have a spatial resolution in the range of the centimeter for the apparatuses into which the entire body of a patient can be inserted, which resolution is poor when compared to that of other imaging techniques such as MRI or computed tomography, which have resolutions in the range of the millimeter. This poor resolution is due to the fact that the positioning of the line of response is erroneous for several reasons inherent to either the principle used or the limits of the detection system. As a matter of fact, the main contribution to the error is the intrinsic resolution of the detector, which is relatively low. One of the main problems contributing to degrading the spatial resolution is thus the difficulty in determining the depth of interaction, referred to as DOI, of the gamma photon in the scintillating crystal. A degradation of the spatial response is observed as one departs from the centre of the field of detection of the apparatus.

Different ways have been explored to improve the accuracy on the DOI of the gamma photon in the crystal, namely the phoswich approach, abbreviation of <<phosphor sandwich>>. This phoswich method is based on the reading, by a single photodetector, of a pile of crystals having different scintillation properties. Most often, crystals having different time constants are used. Each region of interaction produces pulses characteristic shape, that is characteristic for same. Therefore, the analysis of the shape of the pulses permits to identify the region of interaction of each event.

The manufacture of detectors comprised of matrices with scintillating crystals coupled to photodetectors is known. These matrices are formed of small-size crystals, optically isolated from each other by a reflecting material such as Teflon. In this case, one speaks of pixelized or semi-pixelized crystal when the crystal includes a plain upper portion and a pixelized lower portion. The pixelization however results into reducing the sensitivity of detection and into deteriorating the energetic resolution because of the loss of light due to the multiples reflections in the pixel.

Another method consists in using two layers of crystals slightly shifted with respect to each other, by a distance equal to half the pitch of the pixel of the crystal. The scintillation produced in the upper layer indeed illuminates only one pixel of the photodetector. On the other hand, that of a crystal located on the lower layer illuminates two pixels. A decoding algorithm permits to distinguish the two positions, and thus to measure the DOI.

With these different methods, the resolution on measuring the DOI remains limited by the thickness of the crystals, on the one hand, and, on the other hand, by a certain complexity in processing the data.

There also exists a method, referred to as light sharing, which permits to improve the spatial resolution of a PET apparatus. This method consists in installing at each of both ends of a scintillating crystal bar a photodetector capable of measuring the quantity of light received during the interaction of the gamma photon in said crystal. The mathematical use of the values measured by each of both photodetectors permits to estimate the longitudinal positioning of the interaction of the gamma photon in the crystal.

### SUMMARY OF THE INVENTION

The object of the invention is to enhance the performance of this light sharing method by providing the use of a bar formed of at least one scintillating crystal arranged in a particular way.

To this end, the invention relates to an Optical weighing method for measuring a DOI or depth of interaction by estimating the position of impact of a gamma photon in a crystalline medium at the time of the event of said impact, by which an isotropic crystalline medium is transformed into a juxtaposition of sections between which, two by two, are created the conditions for a discrete energy loss of known magnitude, or measurable by calibration, and by which is compared the energy collected at the level of means for measuring the light flux, namely photodetectors, mounted at the longitudinal ends of said crystalline medium for estimating the position of impact of a gamma photon in a given segment of said crystalline medium.

The invention also related to a gamma photon detecting bar designed capable of implementing this method and including at least one single crystal, wherein said detecting bar includes volumes separated from each other and each formed of an intermediate isotropic medium of a type different from that of said single crystal, and with a refractive index different from that of said single crystal.

The invention also relates to a positron emission tomography device including at least such a bar.

Other features and advantages of the invention will become clear from the following detailed description of non-restrictive embodiments of the invention, with reference to the attached figures.

### BRIEF DESCRIPTION OF THE DRAWINGS

FIG. 1 represents, schematically and in perspective, a detecting bar according to a first embodiment of the invention, equipped with photodetectors at its ends;

FIG. 2 represents, in a way similar to FIG. 1, a detecting bar according to another embodiment of the invention;

FIG. 3 represents, in elevation, the bar of FIG. 1;

FIG. 4 represents, in elevation, the bar of FIG. 2;

FIG. 5 represents, in elevation, a bar according to yet another embodiment;

FIG. 6 represents, in elevation, a bar in which a gamma photon impacts;

FIG. 7 represents, schematically and in perspective, a variant of detecting bars, with blind volumes ending on a single face;

FIG. 8 represents in elevation the bar of FIG. 7 according to a direction X of this figure;

FIG. 9 represents, schematically and in perspective, a variant of a detecting bars, with alternating blind volumes ending on two opposite faces;

FIG. 10 represents in elevation the bar of FIG. 9 according to a direction X of this figure;

FIG. 11 represents, schematically and in perspective, a variant of a detecting bars, with blind volumes ending on two opposite faces;

FIG. 12 represents in elevation the bar of FIG. 11 according to a direction X of this figure.

### DETAILED DESCRIPTION OF THE PREFERRED EMBODIMENTS

The invention relates to a gamma photon detecting bar 1.

This bar 1 is designed capable of being integrated into a tomography device, which usually includes detecting rods arranged in the form of at least one detecting ring inside which is placed a body or an organ to be examined. One and the same device may include one or several juxtaposed detecting rings, namely axially.

A body to be examined, namely in vivo, is arranged inside this or these detecting rings. The practitioner using the tomography device tries to diagnose the normal or pathologic functioning of a given organ. To this end, a molecule marked by a positron emitter is administered to the patient. The annihilation of each positron emitted with an electron of the medium gives rise to two gamma photons having energies of 511 keV each and emitted simultaneously in the same direction and in two opposite directions.

The detection of these pairs of gamma photons occurs thanks to a set of detecting rods arranged in the form of a detecting ring, as the case may be axially, radially or tangentially. The LOR joins the positions of interaction of the two gamma photons and contains the position of the positron-emitting source. The intersection of all the LORs detected permits to determine the position of this source.

The ring has preferably a cylindrical cross-section, or a polygonal cross-section close to a cylindrical cross-section, a small length compared to the largest dimension of its cross-section. The peripheral detecting rods are used for determining the location of the points of impact of the gamma photons at the periphery of the apparatus.

The detecting rods of the detecting ring each include one or several detecting bars 1. Advantageously, each of these detecting bars 1 is a scintillating single crystal, namely with a parallelepipedal shape. The crystal transforms the gamma photons into light photons. At the end of each detecting bar are coupled one or several photodetectors permitting to measure the light energy collected at the level of their surface in front of the crystal. These photodetectors are connected to signal-processing means, which are namely in the form of electronic cards. Preferably, each detecting rod is formed of a matrix of detecting bars, which are themselves formed of a scintillating-crystal bar coupled at both ends to the solid-state photodetectors operating in Geiger mode.

In order to obtain a perfectly usable measure, it is necessary to determine the DOI in a sufficiently accurate way.

By reducing the size of the scintillating-crystal bars, for example to 3 mm×3 mm×3 mm, the spatial resolution of the images obtained is improved. However, reducing the size of the elementary crystals increases, inversely to the volute of these elementary crystals, the number of elementary detectors required, which increases the complexity and the cost of the apparatus. Moreover, the size of the photodetectors does not allow implanting them anywhere in the space.

In order to limit this complexity and this cost while maintaining a very good spatial resolution, it is provided, according to the invention, to replace several elementary crystals by a detecting bar 1 of scintillating single crystal, namely with a prismatic and in particular parallelepipedal shape, for example with a size of 3 mm×3 mm×100 mm, so as to limit the number of photodetectors required.

Measuring the exact position of the scintillation produced by the interaction of the gamma photon, according to the longitudinal axis of the scintillating crystal bar, permits to preserve an optimal spatial resolution.

Each detecting bar 1 is provided, at each longitudinal end 2, 3, with at least one light-flux measuring means, namely a photodetector, 4, 5, capable of measuring the light energy E1 or E2, respectively, received at the end 2 or 3, respectively.

The position X on the abscissa, according to the length of the scintillating bar 1 and the direction from the end 2 towards the end 3, with respect to the centre point of the bar 1 taken as zero, of the impact of the gamma photon, is given by the formula: X=k.(E2−E1)/(E1+E2).

Though this formula applies in all cases, the examination of the prior art shows that the uncertainty about this position X, for example in the case of single-crystal detecting bars with polished faces, or also with diffusing faces, is particularly poor. In fact, this absolute uncertainty is then too considerable, in the range of 10 mm, while it is necessary to achieve an accuracy to within 2 to 3 mm, even less.

The invention provides a solution permitting to reduce the range of longitudinal uncertainty of the area of impact on the crystal bar.

Preferably, the detecting ring should be arranged so that a gamma photon, nearing its periphery, arrives there within a continuous material, in order to avoid any loss and, therefore, any inaccuracy and loss of sensitivity. Therefore, the juxtaposition of detecting matrices or detecting bars 1 should allow forming a continuous volume. To this end, a detecting bar 1 is preferably prismatic, with a polygonal cross-section. Should a rectangular or square cross-section be preferred, it can also be contemplated to use bars 1 with a triangular cross-section, eventually mounted alternating with other bars with a triangular cross-section, or with bars with a hexagonal cross-section.

In order to save the number of photodetectors, it is convenient to be able to measure the quantity of light, coming from scintillation, at both ends of a bar.

To this end, according to the invention, the light path in the direction of the largest dimension of the bar 1 is disturbed by volumes 80 of mediums differing from that of the single-crystal bar, but which are all isotropic, transparent to light in all directions, same of these media having a refractive index differing from each other. There is thus formed a number of surfaces of separation intercalated on the path of the light photons. They are arranged so that the passage of each surface of separation results into a loss of light energy.

In brief, obstacles are created on the light path, by changes of medium.

Preferably, according to the invention, the gamma-photon detecting bar is formed of one and the same single crystal, and includes volumes 80 separated from each other and each formed of an isotropic intermediate medium, the nature of which differs from that of said single crystal, and having a refractive index differing from that of said single crystal.

In a preferred embodiment, the single-crystal bar includes external surfaces 11, at least one of which is polished, partially or entirely, in particular when it is chosen with a prismatic shape.

The polishing is preferably performed with a surface state between 1 and 100 nm Ra, and preferably between 10 and 100 nm Ra.

In an advantageous embodiment, this or these external surfaces 11 is or are subjected, partially or entirely, to a particular surface treatment, or/and is or are covered with a deposit, for example of carbon or silver.

One understands that, provided said volumes 80 meet the above definition, they can indifferently be formed by solid, liquid, gaseous bodies, or even vacuum.

Such volumes 80 can have very different geometries, and be limited, as regards their contact surface with the single crystal, by surfaces of any kind:
prisms, the cross-section of which is rectangular, as can be seen in FIGS. 8 to 11, square, triangular, polygonal, elliptic, or the like;
evolutive surfaces such as cones, spheres, ellipsoids, hyperboloids, or the like,
these exemplary surfaces are in no way restrictive.

In a preferred embodiment, at least one, and preferably all, of the contact surfaces the single-crystal bar includes at the interface with one or each of said volumes 80 is or are polished, partially or entirely. If such a volume 80 is made in solid form, it is also advantageously polished at the level of the complementary contact surface it includes at the interface with the contact surface of the single crystal. In an advantageous embodiment, this or these contact surfaces or/and this or these complementary contact surfaces is or are subjected, partially or entirely, to a particular surface treatment, or/and is or are covered with a deposit, for example of carbon or silver.

In a particular and preferred embodiment of the invention, because of its easy and cheap manufacture, some of said volumes 80 are openings. For easiness of manufacture, in a preferred embodiment all these volumes are advantageously openings. These openings may contain, as the case may be, the peripheral ambient medium of the single-crystal bar, namely air, a gas, or also vacuum, or a liquid the flux of which is impeded by closing means the detecting bar then includes for closing these openings.

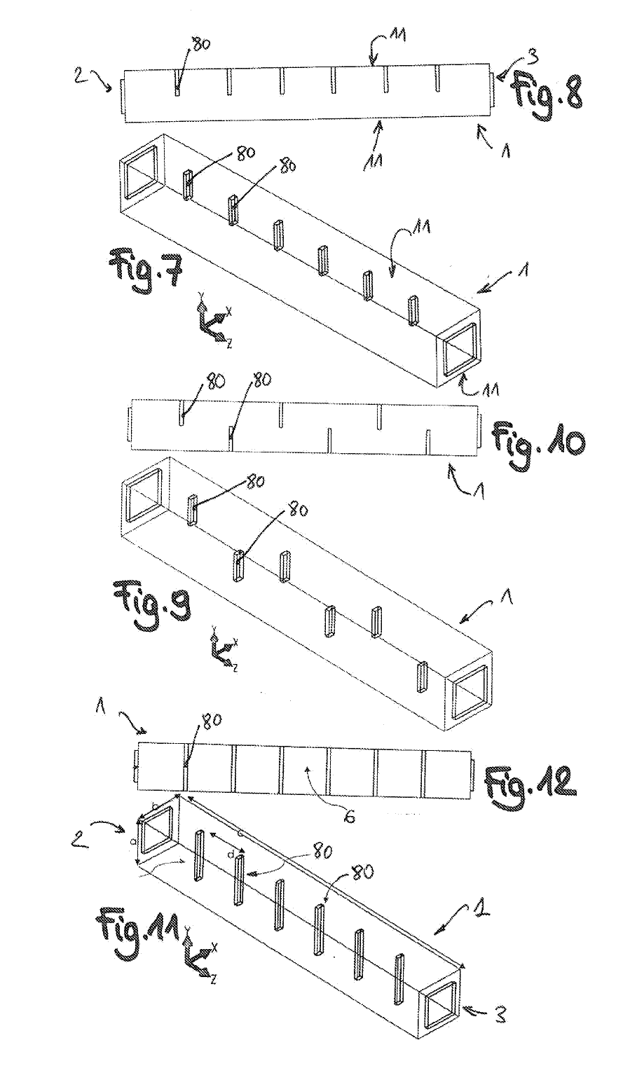

One understands that these openings can be slits as well as openings having a particular cross-section, namely a square, rectangular, circular, triangular, elliptic one, or the like, this cross-section being constant or not, and its shape can be varying within one and the same opening. These openings can be through-holes, i.e. ending on at least two faces of the single-crystal bar, as in FIGS. 11 and 12, or blind holes ending on only one face of the latter, as can be seen in FIGS. 7 to 10. In the case of slits or notches 110, these slits can also completely divide the bar into disjoint segments, in this case the volume separating two segments of the single-crystal bar is preferably formed of a solid material fixed to these segments by gluing or the like. The slits can also relate to only part of the cross-section of the single-crystal bar.

In a particular embodiment of the invention, same of said volumes 80 include at least two parallel faces. They preferably all include at least two parallel faces, as can be seen in FIGS. 7 to 12.

In a preferred embodiment of FIGS. 7 to 12, said volumes each include at least two parallel faces that are parallel to those of the other volumes.

One understands that it is possible to alternate volumes 80 formed of openings, and others including a solid or liquid material, within one and the same bar.

The choice of making volumes 80 in the form of openings, and in particular of small-size openings, which are interposed only on part of the cross-section of the bar on the light path, has the advantage of limiting the loss of light energy, while permitting a good calculation of the positioning of a photon impact, as explained below.

In a preferred embodiment, such an opening can be made by a laser, the dimensions of which at the level of its cross-section are between 10 and 1000 microns.

The choice of a rectangular opening, for example with a cross-section of 50 microns by 400 microns, the 50-micron cross-section being the one corresponding to the longitudinal axis of the bar, provides very good results with a 3×3×60 mm bar of <<LYSO>> single crystal, for example.

The detecting bar 1 is preferably formed of a juxtaposition of prismatic segments 6 of the same single crystal, separated two by two by a layer 7 with parallel faces 8, 9 of an isotropic intermediate medium of a nature different from that of the crystal, and a refractive index different from that of said crystal. The refractive index of said intermediate medium is preferably lower than that of said crystal. The refractive index of each intermediate medium forming one of said volumes is preferably lower than that of the single crystal.

According to the invention, the detecting bar 1 can be a single-piece bar, or formed of the juxtaposition of several elementary prisms 10.

The intermediate medium forming the layer 7 can be of different natures, namely, among the preferred applications: air, optical grease or glue, glass, crystal, plastic, fiber.

The single crystal can be of different types, according to the width of the spectrum related to the light emission according to this determined wavelength, during the interaction of a gamma photon with the crystal. Different types of scintillation products are known, a <<LYSO>> type single crystal is preferably chosen.

One understands that the light emitted during the interaction of a gamma photon with a crystalline medium as that of the invention, and circulating in this medium disturbed by changes in medium, looses energy at each passage of a surface of separation formed by a change in medium between a segment 6 and a layer 7, or vice-versa. In particular, a portion of the light energy can leave the detecting bar during a change in refractive index.

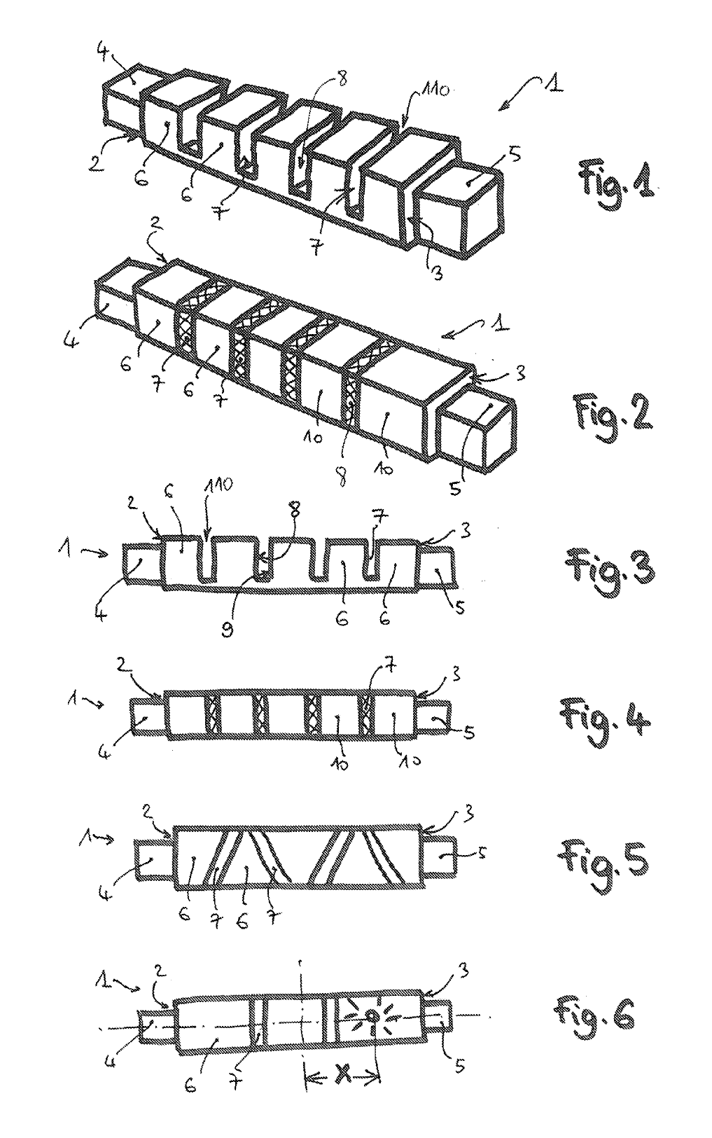

The example of FIG. 1 shows a layer 7 formed of air, made in the form of a notch 110 in the bar 1. The example of FIG. 2 is that of segments 6, 7 of a different nature, juxtaposed on the light path.

The aim of the invention is to bring, at each end 2, 3 of the bar 1, a quantity of light energy, which can be better correlated with the location of the impact of a gamma photon, according to its abscissa x with respect to the length of the bar 1.

The design of the bar according to the invention, based on a loss of energy at each passage of a surface of separation, permits to obtain a reproducible law corresponding to a curve permitting to establish with a high accuracy the position x as a function of the ratio between the light energies collected at the ends 2 and 3 of the bar 1.

Indeed, the passage from one to another of the various sections delimited by the various faces 8 and 9, or by the intermediate layers 7, results into a loss of light energy of fairly regular amplitude.

According to the invention, there is thus created an optical weighing method, for measuring a DOI or depth of interaction by estimating the position of impact of a gamma photon in a crystalline medium 1 at the time of the event of said impact, by which an isotropic crystalline medium is transformed into a juxtaposition of sections between which, two by two, are created the conditions for a discrete energy loss of known magnitude, or measurable by calibration, and by which is compared the energy E1, E2 collected at the level of means for measuring the light flux 4, 5, namely photodetectors, mounted at the longitudinal ends 2, 3 of said crystalline medium for estimating the position X of impact of a gamma photon in a given segment of said crystalline medium 1.

This isotropic crystalline medium 1, namely a detecting bar, is transformed into a juxtaposition of segments, or sections, between which, two by two, are created the conditions of a discrete loss of energy, of known amplitude, or measurable by calibration.

It is thus possible, by comparing the energy collected at the level of the light-flux measuring means 4, 5, namely the photodetectors, mounted at the longitudinal ends 2, 3, of the isotropic crystalline medium 1, to estimate the position X of the impact of the gamma photon in a given segment, namely a prismatic segment, of the isotropic crystalline medium 1.

Indeed, for calculating this position X, the calculation of the difference (E2−E1) adapts discrete values, when it is admitted that the total energy of the gamma photon, i.e. 511 keV, is transformed into light energy during the diffusion into the crystal.

It is known from the state of the art that the total of (E1+E2) is not constant, in the case of fully isotropic bars, with alteration of any kind, and that this variation is in the range of +−4%. This alteration is not enough to substantially alter the calculation of the position X.

It is important not to attenuate too much the light in the various surfaces of separation, because it is necessary to be able to have, at each end 2, 3 of the detecting bar, sufficient energy E1, E2, in order to perform a reliable measurement of same. It is indeed known that a photodetector can measure energy from a threshold in the range of 21 keV.

One understands that the separation of the prismatic segments may not be a total separation. Thus, a single-piece bar including, as can be seen in FIGS. 1 and 3, notches 110 with parallel faces can advantageously be implemented within the framework of the invention. One easily understands that, through such slits, part of the light energy of same rays can leave the crystal, under the action of the diffraction, especially when the notch is too wide. The implementation of the invention requires an experimental search for an optimum between the adequate width of the intermediate layer 7, here of the notch 110 in this preferred example, on the one hand, corresponding to a sufficiently important loss of energy to allow a real differentiation of the various levels of energy and, on the other hand, sufficiently small for a measurable quantity of energy to reach both ends 2 and 3.

This experimental search for an optimum is accompanied by a statistical processing by the Monte Carlo simulation method known in optics. The elements related to this statistical processing are available in the doctoral thesis No. 1181 by Najia TAMDA at the Besancon University, Franche-Comté, France, dated Dec. 18, 2006.

The distribution, depending on the length of the bar, of the relative uncertainty ΔX/X about the position X, can thus be determined by correlation. One understands that it is necessary to proceed to a calibration for each type of bar.

The conventional estimator for the absolute uncertainty of the position range is the WHH, or width at half-height, of the distribution spectrum. Depending on the experimental results, this WHH can be smaller than 6 mm for 3×3×100 or 3×3×120 mm crystals. This value corresponds to a range of +−3 mm with respect to the median value. Therefore, the choice of segments 6 with a small width, namely 3 mm, permits a determination with a very good likelihood of presence of the segment 6 at the level of which the impact of the gamma photon occurred.

But this separation can also be complete, in which case the bar 9 is, as can be seen in FIGS. 2 and 4, reconstituted by juxtaposition of the prismatic segments 10, separated by intermediate media 7.

Other arrangements are possible, for example with surfaces of separation positioned obliquely, for example at 45°, as can be seen in FIG. 5, without departing from the present invention. Using a calibration curve permits a sufficiently accurate estimation of the position and the accuracy of the position of the point of impact of the gamma photon.

In a preferred mode, the invention is constituted by a device for measuring a DOI or depth of interaction by estimating the position of impact of a gamma photon in a crystalline medium at the time of the event of said impact. Said device is including at least one gamma photon detecting bar 1 extending along a longitudinal direction corresponding to the biggest dimension of said bar 1 between two opposite ends. Said device is designed capable of implementing this optical weighing method for measuring a DOI or depth of interaction by estimating the position of impact of a gamma photon in a crystalline medium at the time of the event of said impact. Said device is including at least one single crystal extending along said longitudinal direction, and is including at least one photodetector at each of said ends on flat surfaces perpendicular to said longitudinal direction, wherein said detecting bar includes a succession of single-crystalline bar lengths, each said length being homogeneous, isotropic and full, said lengths being separated by dioptric mediums and/or by openings, said dioptric mediums and/or openings extending approximately parallel with said flat surfaces of said photodetectors.

Said dioptric mediums and/or openings are constituted by volumes 80 separated from each other and each formed of an isotropic intermediate medium of a type different from that of said single crystal, and with a refractive index different from that of said single crystal.

Said single-crystal bar includes external surfaces 11, at least one of which is polished, partially or entirely.

Said single-crystal bar includes external surfaces 11, at least one of which is subjected, partially or entirely, to a surface treatment, or/and is covered with a deposit.

At least one contact surface said single crystal includes at the interface with one of said dioptric mediums and/or openings is polished, partially or entirely.

At least one contact surface said single crystal includes at the interface with one of said dioptric mediums and/or openings is or are subjected, partially or entirely, to a surface treatment, or/and is or are covered with a deposit.

Some of said dioptric mediums and/or openings are openings.

Some of said dioptric mediums and/or openings include at least two parallel faces.

Some of said dioptric mediums and/or openings each include at least two parallel faces that are parallel to those of the other said dioptric mediums and/or openings.

The refractive index of an intermediate medium constituting said dioptric mediums and/or openings is lower than that of said single crystal.

Said gamma photon detecting bar can be made of one single part.

Said gamma photon detecting bar 1 has a length D between 40 and 120 mm, and each said flat surface is between 4 mm² and 36 mm², and single-crystalline bar length extends along said longitudinal direction with a length d between 2 and 6 mm.

The number n of said dioptric mediums and/or openings is preferably comprised between 15 and 25.

The number n of said dioptric mediums and/or openings is preferably calculated as the round number of the ratio value of D/average of the values of different single-crystalline bar lengths.

Said dioptric mediums and/or openings are each calculated to ensure each a loss of luminous energy with a value between α/2n.R.511 keV and β/2n.R.511 keV, R being the light yield of said single-crystal, and value α being comprised between 0.04 and 0.1, and value β being comprised between 0.8 and 1.0, and the cumulated loss of luminous energy corresponding to the theoretical case of the passing of the light through all said dioptric mediums and/or openings being comprised between A.R.511 keV and B.R.511 keV, said value A being comprised between 0.02 and 0.05, and said value B being comprised between 0.4 and 0.5.

These values are chosen to give the best result concerning the accuracy of the measure of the DOI.

The invention concerns still a positron emission tomography device, including detecting rods arranged in the form of at least one detecting ring, each detecting rod being formed of a matrix of devices according to any of claims 2 to 11, wherein each scintillating crystal bar is coupled at both ends to solid-state photodetectors operating in Geiger mode.

In other modes of realization, is it possible to implement other photodetectors on the side of the gamma photon detecting bar 1, which are disposed in echelons on its whole length.

In order to ensure that the measure of the DOI concerns only one impact of a gamma photon, it is good to make a temporal treatment of coincidence for the validation of the reception signals of gamma photons on two detecting bars: the measure is only validated if the time gap between the reception moments on the two detecting bars is lower than a threshold value. Said threshold value has to be lower than 10 ns, and preferably lower than 2 ns.

In order to improve the efficiency of a gamma photon detecting bar 1, it is still possible to create an alternation of different peripheral surfaces having different optical properties. In a preferred node there is at least a first peripheral surface absorbing light, and a second surface with a light absorption index which is different of this one of said first peripheral surface. At least one of these peripheral surfaces is a band which extends perpendicularly to the longitudinal direction of the gamma photon detecting bar. In a best way, the peripheral surface of the gamma photon detecting bar is an alternation of such bands which extends perpendicularly to the longitudinal direction of the gamma photon detecting bar. It is possible to modify the external surface of a single-crystal bar, which is normally polished, partially or entirely, by a surface treatment, or/and a covering with a deposit, for example a black paint with carbon. The surface treatment can be a mechanical or chemical tarnishing of the surface. The different bands may have different lengths in the longitudinal direction of the gamma photon detecting bar. In a preferred way, these lengths are calculated like the lengths of the single-crystalline bar lengths, and their number is calculated in the same way. These band are each calculated to ensure a certain loss of luminous energy calculated like these ones of said dioptric mediums and/or openings.

Therefore, the DOI can be calculated with a good accuracy, and the LOR located within acceptable tolerances. It is thus possible to perform an extremely accurate positioning in space.

The devices and detecting bars 1 according to the invention offer many advantages: reduction of the cost and the number of photodetectors, improved liability, simplification of the electronic circuits.

1. Optical weighing method for measuring a DOI or depth of interaction by estimating the position of impact of a gamma photon in a crystalline medium at the time of the event of said impact, by which an isotropic crystalline medium is transformed into a juxtaposition of sections between which, two by two, are created the conditions for a discrete energy loss of known magnitude, or measurable by calibration, and by which is compared the energy collected at the level of means for measuring the light flux, namely photodetectors, mounted at the longitudinal ends of said crystalline medium for estimating the position (X) of impact of a gamma photon in a given segment of said crystalline medium by counting the number of passages of surfaces of separation between said sections, each said passage of a surface of separation resulting in said discrete loss of light energy of known magnitude.

2. Device for measuring a DOI or depth of interaction by estimating the position of impact of a gamma photon in a crystalline medium at the time of the event of said impact, said device including at least one gamma photon detecting bar extending along a longitudinal direction corresponding to the biggest dimension of said bar between two opposite ends, including at least one single crystal extending along said longitudinal direction, said device including at least one photodetector at each of said ends of said bar on flat surfaces perpendicular to said longitudinal direction, wherein said detecting bar includes a succession of single-crystalline bar lengths, each said length being homogenous, isotropic and without opening, said lengths being separated by dioptric mediums and/or by openings, said dioptric mediums and/or openings extending approximately parallel with said flat surfaces of said photodetectors, and wherein said dioptric mediums and/or openings being constituted by volumes separated from each other and each formed of an isotropic intermediate medium of a type different from that of said single crystal, and with a refractive index different from that of said single crystal, and wherein at least one of the contact surfaces the single-crystal bar includes at the interface with one or each of said volumes is polished partially or entirely, or is subjected, partially or entirely, to a particular surface treatment, or/and is covered with a deposit of carbon or silver.

3.-6. (canceled)

7. Device according to claim 2, wherein all said contact surfaces the single-crystal bar includes at the interface with one or each of said volumes are polished.

8. Device according to claim 2, wherein all said contact surfaces the single-crystal bar includes at the interface with one or each of said volumes and are subjected to a particular surface treatment or are covered with a deposit of carbon or silver.

9.-10. (canceled)

11. Device according to claim 2, wherein the refractive index of an intermediate medium constituting said dioptric mediums and/or openings is lower than that of said single crystal.

12. Device according to claim 2, wherein said gamma photon detecting bar (1) is of one single part.

13. Device according to claim 2, wherein said gamma photon detecting bar has a length (D) between 40 and 120 mm, and each said flat surface is between 4 mm² and 36 mm², and single-crystalline bar length extends along said longitudinal direction with a length (d) between 2 and 6 mm, the number (n) of said dioptric mediums and/or openings being comprised between 15 and 25 and being calculated as the round number of the ratio value of D/average of the values of different single-crystalline bar lengths.

14. Device according to claim 13, wherein said dioptric mediums and/or openings are each calculated to ensure each a loss of luminous energy with a value between α/2n.R.511 keV, (R) being the light yield of said single-crystal which is a “LYSO” single crystal, and value (α) being comprised between 0.04 and 0.1, and value (β) being comprised between 0.8 and 1.0, and the cumulated loss of luminous energy corresponding to the theoretical case of the passing of the light through all said dioptric mediums and/or openings being comprised between A.R.511 keV and B.R.511 keV, said value (A) being comprised between 0.02 and 0.05, and said value (B) being comprised between 0.4 and 0.5.

15. (canceled)

16. Device according to claim 2, wherein said single-crystal bar includes external surfaces, at least one of which is polished with a surface state between 10 and 100 mm Ra.

17. Device according to claim 2, wherein said single-crystal bar includes external surfaces, at least one of which is subjected, partially or entirely, to a surface treatment, or/and is covered with a deposit of carbon or silver.

18. Device according to claim 2, wherein some of said dioptric mediums and/or openings are through-holes openings.

19. Device according to claim 2, wherein some of said dioptric mediums and/or openings each include at least two parallel faces that are parallel to those of the other said dioptric mediums and/or openings.

20. Device according to claim 7, wherein said through-hole opening is prismatic, the cross-section of which being rectangular, and made by a laser, the dimensions of which at the level of its cross-section are between 10 and 1000 microns.

21. Device according to claim 2, wherein said volume (80) is a prismatic split, the cross-section of which being triangular.

22. Positron emission tomography PET-device, including detecting rods arranged in the form of at least one detecting ring, each detecting rod being formed of a matrix of devices according to claim 2, wherein each scintillating crystal bar is coupled at both ends to solid-state photodetectors operating in Geiger mode, and said PET-device including for each said gamma photon detecting bar a calibration curve which permits an estimation of the position and the accuracy of the position of the point of impact of the gamma photon.
